(19) United States
(12) Patent Application Publication
(10) Pub. No.: US 2006/0126771 A1
(43) Pub. Date: Jun. 15, 2006

(54) Propulsion motor

(76) Inventor: Jose Da Conceicao, Petrolis-Rio de Janeiro (BR)

Correspondence Address: TRASK BRITT, P.O. BOX 2550, SALT LAKE CITY, UT, 84110, US

(21) Appl. No.: 10/528,225

(22) PCT Filed: Mar. 27, 2003
(86) PCT No.: PCT/BR03/00046

§ 371 Date: Oct. 31, 2005

(30) Foreign Application Priority Data
Sep. 19, 2002 (BR) P10205584-8

(51) Int. Cl. H05H 1/22

(52) U.S. Cl. 376/100

(57) ABSTRACT

A propulsion motor for rockets and spaceships comprising two cylindrical rings (17) linked by means of a bar (18) forming the motor external structure (17,18) and an exhaust (13,14,15) linked to a third cylindrical ring (17A) and to a reactor room (16) where nuclear fuel (3) explodes and generates a beam (8) directed to another nuclear fuel (10) inside the exhaust (13,14,15) which produces a thrust to a reflector magnetic field (12) and the hot plasma avoids touching the exhaust wall (13). To initiate reactions in the reactor vessel (6) and in the exhaust (13,14,15) an injection system (19) and a production system (20) the fuel (3,10) are needed.

### BACKGROUND

The present invention reports to an improvement in the motor and processes and from the state of art, relative to a reaction motor with nuclear fuel, with purpose to propulsion spaceships, prototypes a rocket with specific impulse 10⁵ sec or more, more than obtained for nuclear fission reaction (only comparable with micro fusion) or chemical reactions, due to a high temperature and a high velocity from the thermonuclear fusion reactions, the impulse is greater than in the DT models, due to the high-ignition temperature in nuclear reactions of the fuels in the present invention, and to be charged particles, how in the DHe3 reaction, a proton of 14.7 MeV (indeed, a neutron of 14.3 MeV) and an alpha particle of 3.6 MeV, or 100% in charged particles. Due to repulsion by a magnetic field of the charged particles, also to not permit the hot plasma to touch material walls that the exhaust is made, to has an idea, tokamaks support 300 million degrees or the fuel Tₓ DHe3 to furnish greater impulse in the same power by reaction, what is required is lower fuel mass by reaction, or millions of degrees and thousands of km/s also proportioning high thrust (nuclear micro explosions) due to high-energy density and temperature. Beyond the beams also being produced by micro/mini fission or micro fusion reactions, having ignitions (explosions) of this fuel, with cylindrical or spherical target, or any other processes of inertial fusion/fission (z-pinch, MTF) to generate micro fusion/fission and, therefore, the beam.

### SUMMARY OF THE INVENTION

The fate to mention a prototype, the more simple object is linked to the motor, slowing the mass motor that will be scaled after, will be a test prototype that will carry a reading tool and cameras.

In U.S. Pat. No. 9,303,792, the motor is made up of two cone trunks placed some distance from one another. In the short cone and around, has many energetic beams fired to the target (inside short cone), tolerated only by illumination by indirect drive, due to that configuration. Beyond the target stay restricted to a small area to be fired by the drivers.

In the Petition No. 9715026, as in the technical exam opposition from this petition, the drivers are internal between the exhaust and motor revestment producing an angle less than 90 degrees in the z-axis (cone weight) and not forming a full direct drive, or corona formation, although some mirrors are placed in a not specified locale, as well as in that opportunity in the technical exam opposition the novelties were omitted to be written in the claims.

In the Scientific American from January 1999, the model is the micro fission fusion in the exhaust, like in the November 2, 1997, Super Interessante, the drivers are external to the body motor, and fired to the target which is placed inside a half cylindrical bottle, and is a completely different conception. Later in the Internet NASA pages, the driver was generalized for inertial fusion on Jun. 14, 2001, with the purpose of initiating a micro fission and after a micro fusion in the exhaust (Advanced propulsion concepts), including the VISTA model, whose drivers are placed behind and parallel to exhaust cone weight and directed by mirrors to nuclear fuel targets, and the reactions take place in the exhaust base short cone, and in the present invention some laser guns are inclined and others are perpendicular to the z-axis and in enough numbers placed in the exhaust cone tall base, that is, in the opposite side of the VISTA model for fast ignition case, with the need for corona formation. In other cases in the present invention, the drivers are placed and generated in a reactor vessel room between the exhaust external motor structure.

The limitation in the nuclear fuel is another problem, prior to the Patent case, be restricted to a DT and DD making a reasonable neutron quantity, carrying 80% energy, needing hard structures (rising motor mass with this fuel and losing velocity) to produce more fuel or to absorb neutrons. The DD reactions produce tritium, having, therefore, DT reactions, yet the temperature needed in the ignition of DD reactions is a billion Celsius degrees and in the DT reaction, 100 million Celsius degrees. In the DHe3 reactions are needed 600 million Celsius degrees and in the T_{X}DHe3, 300/400 million Celsius degrees.

Therefore, the fuel is DT in the VISTA model.

In Petition No. 9715026, the fuel is DHe3, and in the micro fission fusion, the fuel is Uranium and DHe3 (ICAN-I).

The ICAN-II was generated by DT and DHe3 and initiated by micro fission on Jun. 14, 2001.

Another problem with the proposed fuel is that the stored quantity for the motor mainly for interstellar travel, and in the VISTA case are 4000MT.

Another problem is that the energetic beams proposed in U.S. Pat. No.9,303,792 were not specified to initiate second generation nuclear fusion fuels (neutron-free or low-neutron concentration to initiate nuclear fusion reactions) needing more powerful beams configuring how conventional beams or only get the compression or corona formation, although of advanced fuels is a rarity, however, this is solved.

In Petition No.9715026 the drivers were mentioned but not specified, and in the technical exam opposition, were omitted.

The driver in the VISTA model is a beam of a conventional laser, without mention of another nuclear fuel or another energetic beam.

In the micro fission fusion, the drivers are beams of antimatter or antiparticles (ICAN-I), generalized to present laser and particle beams on Jun. 14, 2001, (ICAN-II) to initiate micro fission and after DT and DHe3 fusion reactions inside the exhaust, is another conception.

Another problem is the exhaust vessel elaboration, where in the prior Patent due to nuclear fusion fuels, needs many shields (5) to protect magnets, to breed tritium to make new fuels. In the DD reaction where the specific impulse is the best, but only DT does not furnish enough temperature to ignite DD without He3, and is not mentioned in that document.

In Petition No.9715026, the shield modification is mentioned, but not specified that can be noted change according to the fuel to be used. In the present invention, the shield changes to lower motor mass so that to travel relatively short distances it made a difference, but for interstellar travel, it did not make a difference.

As well as, in the VISTA model that is at DT but not use the producer shield since carry your own fuel, second that model are 4000MT of fuel, are preferable the producer shield or a reaction vessel if the case is to produce as much fuel whatever the x-ray or gamma-ray mean drive, how is in the present invention.

Due to exhaust configuration in the micro fission fusion (ICAN-II), how can support 600 million degrees without a magnetic field, that is, to avoid the hot plasma and to arrive at the exhaust constitution. If so, the tokamaks do not need a magnetic field, moreover in the motor which, in some cases, the explosions have 20 tons of TNT or more, or the exhaust vessel may be very large, so the radiation does not touch the wall.

Another problem is that the present drivers, after nine years from prior Patent have not yet begun the ignition and combustion. The present invention illustrates how to obtain beams with enough intensity without waiting for before-mentioned drivers, and in a simple manner one can test the system at any time with micro fission or mini fission (which can be obtained at any time) and the fusion, agreed description mentioned hereafter where in some cases, many beams can be generated at one time. The novelty beam of the present invention can be used in ICF reactors for energy production.

Already in the micro fusion, indeed detonation like in Orion project explosions nearly kt intensity, explosions nearly tons of TNT where the fuel is U₂₃₅/DT composite, in some low quantities, but low quantities are not as useful for propulsion and military explosions, but are sufficient enough to produce the beam. The advantage of the present invention is that explosions take place in a reactor room vessel producing a beam that will fire only fusion in the exhaust, giving greater specific impulse rather than fission initiated, scaling the present invention to advanced fuels in the exhaust. Beyond the storage mass needed, even in a track near the frontier of our Solar system is a storage mass that is 50 times greater than needed to make the beams due to the problem of storing so many radioactive materials and the exhaust will need a heavy shield due to neutrons, since 1 ton of TNT and the neutrons are lethal to 100 m.

The Vasimir project and the gas dynamic mirror (GDM), that consist to produce and inject a plasma (fusion, or not) that is retained in a cylindrical vessel by magnetic fields, where this plasma is heated by radiation in the Ghertz generated by an antenna, was projected to initially work at hydrogen plasma and not fusion, what will happen after get fusion and the velocity is near 30 km/s.

Therefore, the purpose of the present invention consists in obtaining a solution for the above-mentioned problems. The chirped pulse amplification (CPA) has the merit to change present laser beams from kJ in laser pulse nearly 10²⁰ w/cm² or more, but has other lasers and particle beams in this intensity, being actually possible with this to initiate nuclear micro reactions in the reactor or vessel of contention (and not in the exhaust) cited in the present invention, or even neutron beams generated by a laser to initiate a micro fission in the reactor room or reaction room.

According to micro explosion, intensity is not useful to propulsion, therefore, today make nuclear fusion in ICF, but in the MJ and without receiving ignition or target combustion. Some inertial fusion processes, like z-pinch and MTF, are adequate to produce radiation energy, wherein the reactions happen in a billionth of a second duration (same time that it takes radiation to reach the cylinder in the Centurion/Halite project), without has, therefore, fuel ignition or without chain reaction, however produces enough energy in the form of x-rays and gamma-rays that are more piercing and useful to direct drivers, that is one of the conceptions used in the beam's elaboration proposed in the present invention making some adaptation in the fuel. In this technique, searching a fuel micro explosion with a conventional ICF method or not (or with chemical high explosives) from micro fission and micro fusion to aid in the energy production in radiation form, which is more simple to achieve, because in a nuclear explosion the radiation travels at light speed reaching the cylinder placed near the nuclear micro/mini explosion before any other hydrodynamic phenomena and in a reactor placed out of the exhaust to generate the beam that will be directed to the target inside the exhaust vessel. In another case (0.1 g P_{U}) detonation with chain reaction, that can be retained in a steel or carbon composite vessel (3.5 m in diameter) inside and lead out, since with 1 ton of TNT the neutrons are lethal at 100 m, and since so many cylinders are needed (the minimal possible, due to specific impulse) to beam formation directed to the target inside the exhaust, or using mirrors to direct the beams to a fission/fusion reactor, like z-pinch RTL to breed tritium, inside the spaceship with the energy purpose and the elements needed for other beams, which is an advantage and a novelty.

To deliver the target and to make possible an actualization of the two illumination type (direct/indirect drivers) and several beams and fuels, that is advanced fuels with low tritium percentage constitution, or catalyzed by tritium, or only pure advanced fuels. Target position can vary from cone center to exhaust tall base cone and the exhaust cone ray also in models with advanced fuels or that require more energy than micro explosions.

To obtain reactions initiated by DT, and how mean fuel DHe3, with fast ignition concept what must last a long time in present experiments or use the direct drive illumination since a pettawatt laser (PWL) directed by direct drive to a DT target, will only expel the electrons of the fuel materials without accomplishing its finality. Therefore, there is a need for, the corona for laser matter interaction or change target constitution and the beam. What is needed are two drivers, one for corona formation (LIF, HIF, laser) and a high-power laser to inject a hot spot ignition (fission/fusion in cylindrical/spherical target beam, micro Centurion/Halite, future high-power laser) the drivers' position is inside, between the external revetment and the exhaust cone, therefore, this configuration requires more mass in the beam, but less mass than in a conventional ICF.

For indirect drivers, that do not need corona formation, but only need a powerful driver to bath the holhraum and x-ray generation, the proposed beams where directed to the target, with a change in the target constitution.

The next generation drivers have a tendency to be compact and powerful, and with one- or two-sided illumination obtain primary fuel fusion, and since the mean fuel, the catalyzed and advanced, the present invention proposed beams, that in some cases may be placed in front of the exhaust short base cone, or on the opposite side of the exhaust tall base, lowering the extra mass of the laser/particle gun by indirect drive, or by direct drive, with a target to x-ray gamma-ray absorption.

To produce the energetic beams that will possible pure advanced fuels can mount an inertial fusion/fission reactor to generate the beam and obtain a variety of intensities scaling with mass used in each micro explosion in reactor and the cylinder used to simulate the x-ray, gamma-ray laser, similar to the Centurion/Halite, in this case, can be placed in the exhaust tall base cone and out of external revetment from the exhaust, with this, can change the intensity from reactor micro/mini explosions with the purpose to obtain more powerful beams, because in an x-ray laser, so much more intense will be the source pumping greater than will be the laser intensity, or is proportional to the intensity of detonation, by one's turn is limited to mass in the detonation due to a specific impulse. Comparatively, being possible the detonation of 1 kg P_{U} initiated by laser and magnetic fields or chemical high explosives, in this case the velocity is near 26 km/s due to a specific impulse, the same order of magnitude from z-pinch LMTL second the following equation (1):
Vₑₓ=\sqrt{2}E_{PN}/m (1)
where Vₑₓ=exhaust velocity(km/s); E_{PN}=energy production in each nuclear reaction (GJ); m=fuel target mass (kg). In this case, the expended mass in the beam generation by any processes (cylinder mass used to beam generation+fuel mass to beam generation+fuel mass used in the exhaust).

The laser and particle beams can be changed in some places in the reactor room or vessel of contention where the beam is generated and in the terminal part by mirrors directed to the nuclear field target in the reactor to generate the beam, lowering the mass in the reaction room due to laser guns.

The energetic beam system in some cases, for fast ignition concept, first is used a low-power beam (conventional particle beams and laser beams) only for corona formation and after a high-power laser (fission fusion x-ray/gamma-ray laser, or x-ray beams by nuclear pumping) to heat the fuel to ignition conditions, beyond introducing low tritium proportions in the constitution in the exhaust nuclear fuel (T_{X}DHe3) that has a lower temperature ignition than DHe3 and having a low neutron production requiring a less dense shield, or DT producing a wafer type to insert DHe3, and when the system is optimized to use metallic hydrogen in the DT microspheres constitution for, detonation. DHe3 is inserted in the microspheres for a greater deuterium proportion to initiate DD reactions require a higher temperature than the DHe3 reactions.

When the energetic beams to be used are the fission/fusion with cylindrical or spherical target directly, or by a reactor, can get advanced fuel ignition without the need for low tritium proportion, with the need for some symmetry in the beam impact in the fuel target (spherical/cylindrical) due to direct/indirect drive. How are energetic beams and conceived from a singular reactor, placed in the interior between exhaust cone and internal revetment and in the exhaust tall base cone. Varying mean beam intensity according to reactor fuel mass, or in the case where don't need very intense micro explosions or in the case of a single HIF beam are directed against a cylindrical DT_{X}He3 target, the driver system is placed in the exhaust short base cone. Due to the reduced number of guns needed with this beam reduction, since with fission explosions less than 5 tons of TNT is more practical than a fusion micro explosion compared to beam generation. An example is detonation of 10 g/50 g from P_{U} by chemical high explosive that is more compact than any other method, and more economical. One possibility is across cylindrical millimeter chemical explosive lenses initiated by the laser or conventional detonators, depending on the type of lenses, and the millimeter/centimeter cylinder distributed around the Pu/U sphere, that generated blast waves making a symmetrical compression, similar to classical lense bombs. The modern low-yield thermonuclear explosion has been substantially microed from football sized pack back to gum, or grapefruit size in SADM configuration, like a micro nuke bomb, but an English site made an allusion of a series of lenses in a bi-conical shape, composite of classical nuclear material, but this can be developed not for war, but for the purpose of the present invention. Likewise, is a reactor that will retain fission/fusion explosions and radiation to produce an energetic beam which is directed to the target in the exhaust, not raising the mass, because in all before-mentioned documents the reactor and the beam are the same thing or the external beams are directed to the target inside the exhaust producing this set the reactor.

The motive to discover fission reactions less than 10 tons of TNT is the order of magnitude, the need to initiate fission reactions in this scale is in the kJ, that can be verified is the same order of magnitude from liberated energy composite B-type explosives, or with less quantities than chemical explosives being possible with present lasers (micro mini chemical explosive lenses initiated by laser, generating blast waves in many points of a sphere) but difficult to compress such mass, however, in fusion, the laser energy is near 2 MJ that is the present state of art. The micro fission can be initiated by laser, mini fission is actually not far beyond this fission can be modeled in the explosions and the explosions result (radiation, blast, heat, etc,) and the mini fission can be obtained with few mass (W 54 light detonation) or less, or light variations of SADM. Or through present invention with laser, particle beams and magnetic fields, will be discussed ahead.

But the plutonium choice is due to critical state be obtained with less mass quantity than uranium. But the need of plutonium is high ¼ kg for each laser shoot, without chemical explosives needed in the detonation, or if it were possible to initiate with laser or particle beams and with magnetic field compression, even so it will have a velocity near 26 km/s, since z-pitch LM-TL for propulsion needs 80 kg and will have 30 km/s with an explosion near 1 kt.

Another solution with the proposed method is to obtain the beam across micro inertial fusion reactor, considerably lowering the order of magnitude from matter needed for mean drive elaboration across a target of low-temperature ignition (high density), once the order of magnitude in driver intensity is 10 kJ, lowering beam intensity in a cylindrical target is proposed, concentrating the energy in a cylindrical axis rather than in a sphere. The computer simulation being confirmed by this method will be one of more practice. However, this has been emphasized and is important due to a specific impulse. Micro fission requires drivers from greater order of magnitude than micro fusion, but are easier to get, in some cases. Fission can diminish the nuclear fuel mass without losing detonation intensity.

The plutonium ignition temperature is near 1 keV since it is DT 5 keV and DHe3 30 keV. Comparatively, 1.23 g of plutonium with ray 0.004 cm, the driver energy necessary to initiate the reaction is 10/24 MJ and produces 4.1.10¹⁷ erg, therefore, in a plutonium sphere with ray of 5 cm will be needed laser in the kJ, since the energy in the B composite is near 5 kJ for each kg, being needed 110 kg giving 550 kJ, but difficult to compress such mass with present drivers and the plutonium produces in this reaction 2.4.10¹⁸ erg one order of magnitude more than micro fission generating thermal x-ray radiation in the explosion near 10 GJ enough to make x-ray and gamma-ray laser in this intensity and initiate fusion reactions inside the exhaust and 3 kg of plutonium produces 0.004 kt, i.e., 1.6.10¹⁸ erg in some conditions, or W54 variation weighing near 16 kg and produces 10 tons of TNT. However with 0.1 g from plutonium (with DT mass variation in the plutonium center), the driver order of magnitude is 1 MJ (promptly obtained) with the help of magnetic compression or magnetic isolation, can reduce the incident driver energy, but with enough production generating without DT in the fission mass 1.7 tons of TNT to generate the proposed energy driver and raise fuel pressure and the density of the critical mass falls with the fuel mass lowering beam intensity needed, or the critical falls with fission mass. Lowering the P_{U} mass to 0.01 g with or without Be reflector reduces the energy needed in the beam to 100 kJ and produces 0.17 tons of TNT, i.e., 714 MJ and 10% fuel burn 71.4 MJ. Like in a nuclear explosion 50% is in x-radiation having the beam intensity near 36 MJ, 20 times all NIF beams. The objective is not made a nuclear artifact, but this analysis shows that the objective is to obtain an ignition (detonation) large enough that x-ray or gamma-ray from such micro explosions can vaporize a cylinder with x-ray transparence material (low Z material) in the cylinder extremity making the laser, where the following Table 1 illustrates the minimal P_{U}/U mass values to produce the beam and enough intensity for nuclear fuel ignition by scaling explosion if needed, according to intensity need.

| Fuel | yield | 10% burn | Equiv. | Diam. | | |
|---|---|---|---|---|---|---|
| mass(g) | (ton TNT) | (ton TNT) | (J) | Expl. | Driv. Eng. | |
| 0.001 | 1.76 · 10⁻² | 1.76 · 10⁻³ | 7.4 MJ | 0.42 m | 10 | kJ |
| 0.01 | 0.176 | 1.76 · 10⁻² | 74 MJ | 0.92 m | 100 | kJ |
| 0.1 | 1.76 | 0.176 | 740 MJ | 1.97 m | 1 | MJ |
| 1.0 | 17.6 | 1.76 | 7.4 GJ | 3.50 m | 0/20 | MJ |

With this analysis arrive at proposed driver, initiated by micro fission fusion, that consists of cylindrical tube made up of gold, aluminum, or tantalum in one side fulfilled with 0.1/0.2 g from uranium plutonium with DT mass 1 μg in plutonium center. In this technique, it can use solid or hollow cylinders bombarded with particle beams by direct drive. With particle beams, the model that gives greater pressure and temperature is the hollow cylinder configuration and the beam with annular spot (hollow beam) and with the same cylinder fuel ray being symmetrically heated by incident circular beam and producing the plasma compression in the cylinder axis that can be injected into a fast ignition energy through a gold cone perpendicularly directed to this axis. With laser by direct drive are possible explosive shock waves with solid cylinder targets and the laser beam directed to the cylinder axis. Being gold, the cylinder material and using the PWL and due to its intensity, many nuclear processes happen when it is shocked with the solid material and due to material type and some processes manifest more than others. For DT compression, two shields are needed, one of gold where the PWL expels the electrons and this shocking with aluminum produces x-rays that heat DT to the ignition point. P_{U} compression requires a gold shell to be reached by PWL producing neutrons, anti-matter, etc., in this nuclear process that arriving the P_{U} shield joins with the shock wave made by the laser impact with an Au shell produce the fission of P_{U}. The evolution to fast ignition is adapting a gold cone (better spot at 30°) to attain the region of compressed plasma with fast coronal ignition method (FCI), where the ignitor beam cone can be in the Pu/U shell and the compression is made in the DT shell, or the ignition beam cone in the DT shell and the compression in the Pu/U shell in cylindrical or spherical geometry. The most adequate is the compression of P_{U}/U generating neutrons and heating the DT shell and after to ignitor cone, beyond the target normally used in an ICF search that has a tamper, pusher and the cylinder rod that produces the laser launch separately from the fuel target in the reactor. An idea with CPA laser in the USA is to make an ion accelerator with a CP-A laser. The above idea from the present invention is to simulate in another scale the Centurion/Halite project, indeed a kt nuclear explosion a micro fission where the high-intensity radiation from these explosions in a short time made the laser pumping arrive at a cylinder rod from aluminum or another high Z material and the cylinder is positioned directed to the exhaust target.

By indirect drive which both consist in holhraum variations with fast coronal ignition (FCI) but in this case the lasers are more efficient to heat the holhraum. Then, according to the target type, the cylinder that produces the mean laser and is launched separately in the reactor from the fuel target.

Another method is to profit the fission facility to diminish mass using 0.001 g of plutonium/uranium (and μg from DT inside this P_{U}/U shield mass) needing in the beams near 10 kJ to initiate P_{U}/U micro explosions and after DT, the x or γ radiation reach the cylinder, vaporizing it, having transparence lenses to x or y radiation producing this manner the laser, in this case, the cylinder is mounted in a capsule around the target, i.e., the target and the cylinder are one thing. Or injecting as well as cylinder whatever the fuel separately across wall orifices in different places not needing the capsule, but is the same principle. Like is a metal your trajectory can be scanned by laser and computer calculations and positioned a magnetic field.

The advantages of this system are micro explosions that will be retained in a short cylinder from 42 cm in diameter, since explosion diameters are proportional to cubic root explosion intensity, illustrated in the following equation (2):
0.32³\sqrt{E}_{PN} (2)
where E_{PN}(kg TNT) is the nuclear yield, generating the laser with an axial magnetic field in the cylinder brings into action moments before implosion (beyond to avoid loss of fuel entropy) and retaining the energy in the cylinder, obeying the condition BR>10 Tm, that is possible with present magnetic fields (not z-pinched, but this is possible with z-pinch fields and in a combination that is an axial only or axial and radial magnetic fields). In the case of the axial magnetic field, the incident driver is a single particle beam (HIF) with a circular symmetry that arrives at the cylinder fuel shield under the tamper in the reactor target. In two other cases, the incident driver is the conventional ICF method with a radial (or mix) magnetic field. Due to small size dimensions in radial magnetic field, the energy needed in the magnet can be obtained by storage capacitors that fire in a short time the energy to the magnet that exploded after a time, generating very high compression needed in micro fission reactions, similar to a wire array z-pinch. The magneto in ambient temperature and for axial field are made of copper wire strengthened by fine filaments of aluminum, silver or niobium with support from fiber glass or carbon composite generating magnetic fields near 70 T in a pulsed regime, since pure copper will not support the strong stress that the magnetic field applies to the magnetic, beyond how strong wire diameter less capacity, or without magnetic field, since in this mass scale fission the driver is promptly obtained (ICF or chemical high explosive methods), since this field is used where mass fission raises and requires more energy in the driver to initiate micro fission. The advantage of magnetic fields is to avoid a loss of energy needing less areal density and energy in the beam. This has an advantage to the z-pinch since the repetition rate is high, therefore, in conventional z-pinch is low (sufficient to feed a laser with a high repetition rate, as proposed in the present invention) although producing actually 2 MJ of x-radiation, more than 1.8 MJ from NIF and upgrading to 16 MJ in the x-ray driver energy, or in the fast z-pinch, where the z-pinch is adapted to fast ignition and is used to detonate the fuel inside the exhaust. The difference in the present invention made a x-ray laser, the z-pinch systems made a x-radiation or the z-pinch plasma is launched in the exhaust, beyond in the present invention the x-radiation or x-ray laser radiation is used to make a mean driver in a reaction vessel for after initiating inside the exhaust the nuclear micro fusion of advanced fuels or not, and has more efficiency than in the micro fission fusion (ICAN-I) that has a relatively powerful and expensive driver to produce the same results, therefore, after driver generalization (ICAN-II), to initiate a micro fission followed by fusion, but detonates the fuel inside the exhaust.

Or only fission, since the order of magnitude in the driver energy to generate 10/100 MJ is below the generated energy in the processes. However, the neutrons, from DT_{X} reactions in the plutonium center, increase the fission reactions simulated in a lesser scale the Centurion/Halite project, having the fuel a cylindrical or ellipsoidal shape.

In the less-explosive case, the reactor localization is on each side of the exhaust tall base cone, internal, between the revetment and the exhaust. In this case, it is more practical to initiate low quantities of Pu/U (mg/g) by chemical explosive lenses (with 0.5 mg of silver azide obtained from cylindrical blast waves) initiated by the laser. With the help of nanotechnology in the improvement of high explosives (and raising the chemical mass of high explosive and nuclear explosive in the same proportion) in one order of magnitude according to the following calculation, known that 0.1 gU is needed 100 kJ in the driver and the energy density of high explosive 6 kJ/g calculating the volume the ratio is two orders of magnitude assuming 100% coupling. In fusion, with the same calculation, the volume of chemical explosive is five orders of magnitude greater. Needed is 1 to 10 g of high explosive for detonation on 0.01 g of U being viable the more practical and economical system to initiate a micro mini fission explosion to produce the beam and, in this case, the reactor is only the contention vessel. The high chemical explosives do not have the velocity and energy to initiate a pure fusion but are adequate to begin a micro mini fission from the same order of magnitude from high explosive mass, with fission detonations less than one ton of TNT to produce the beam.

When, in a more explosive reaction, the place of a reactor is out of motor revetment, or made of a three vessel system where two of them are placed in opposite sides of the exhaust tall base cone, generating the laser beam directed to the target inside the exhaust, or directed to another reactor inside the spaceship. The reactor is able to support micro mini fission reactions. Comparatively, it is possible to retain 1.7 tons of TNT in a modest steel vessel, and in the present invention, due to magnets, a lead shield is needed to retain the neutrons or carbon-carbon composite having high heat resistance or graphite or a HYLIF configuration to retain the explosions. This conception has advantages over micro fission fusion (ICAN I/II, micro fusion), as the exhaust is free of neutrons from fission, lightening the shields for neutron free fuels, beyond to proportion a better conception about the reactor or reaction vessel of contention that will generate the driver and how to retain neutrons and being better to manipulate than in the exhaust.

With nuclear fusion reactions, raising the microspheres' mass from the exhaust lowers the driver intensity, what can be obtained by fast ignition methods or by indirect drive with present drivers. Comparatively, in mini fusion to initiate a reaction are used explosive plastic lenses, producing an artifact of 10 kg called a “baseball bomb” producing nearly 1 ton of TNT. The specific impulse is low, being the mass limit 1 kg. Using the present invention method initiating by laser, particle beams, etc., and with the help of a magnetic field, we can lower the matter quantity used in the nuclear driver elaboration from milligrams to micrograms, since 1 mg of DT produces 334 MJ while 10% of burn produces 33.4 MJ and 50% (x-ray/γ ray) 16.7 MJ in x-radiation or gamma radiation, that is 10 times more energy is introduced by laser in the NIF, and five times more the production of 1 mg of U, see above. This reduces the mass required to produce fuel, with two reactors in each side of 70 kg/yr that is reasonable for deep interplanetary voyager, and the specific impulse depend approximately of the exhaust fuel.

| Model | Driver mass | Exhaust mass | burn % | Cylind. Mass | Iₛₚ | v |
|---|---|---|---|---|---|---|
| Vasimir (GDM) | — | ? | | — | 4000 | 30 km/s |
| Z-pinch LMTL | — | 80 kg | | — | 4000 | 30 km/s |
| Pres. Invention | 1 kg | 1 g | 100 | 4 × 10⁻³ g | 2617 | 26 km/s |
| Idem | 1 g | 1 g | 100 | 4 × 10⁻³ g | 88399 | 817 km/s |
| Idem | 1 g | 1 g | 50 | 4 × 10⁻³ g | 58972 | 573 km/s |
| Idem | 1 g | 1 g | 10 | 4 × 10⁻³ g | 26373 | 258 km/s |
| Idem | 1 g | 1 g | 1 | 4 × 10⁻³ g | 8399 | 82 km/s |
| Idem | 0.01 g | 5 × 10⁻³ g | 100 | 4 × 10⁻³ g | 83399 | 817 km/s |
| Idem | 0.01 g | 5 × 10⁻³ g | 50 | 4 × 10⁻³ g | 58972 | 573 km/s |
| Idem | 0.01 g | 5 × 10⁻³ g | 10 | 4 × 10⁻³ g | 26373 | 258 km/s |
| Idem | 0.01 g | 5 × 10⁻³ g | 1 | 4 × 10⁻³ g | 8399 | 82 km/s |
| Idem | 1 × 10⁴ (Fus.) | 5 × 10⁻³ g | | 4 × 10⁻³ g | 81004 | 793 km/s |
| Ideal case | 0 | 5 × 10⁻³ g | 100 | 0 | 83398 | 817 km/s |

Table 2 references how the energy is produced by DT and mass of U235 and DT, for DHe3 is the same data but with less fuel mass; burn %=percent of nuclear fuel burn in each case, and the classification made in internet NASA pages, where it is stated that a great part of the present projects regarding fusion, anti-matter, and fission, are not proven technologies. A second way of thinking to go rapidly on to the next step, or proved technologies, are z-pinch LMTL, Vasimir/GDM, micro fusion, and the present invention, since some comparative data. To give an idea, the energy production needed in micro explosion is 144 GJ for a velocity of 30 km/s and a waste mass of 80 kg in the processes and a corresponding fuel mass of 1 g of DT and 50% of fuel burn in the z-pinch LMTL according to equation (1). In the present invention, 5 mg of DT and 1% of fuel are burned, the velocity is 82 km/s, the mass consumed by second is 200 times less, and with 30% of fuel burned, the velocity is 500 km/s with the same amount of mass (5 mg) that is feasible. Yet, in micro fusion (new Orion project) has comparatively the same values as the present invention, but while it raises the yield and uses advanced fuels, the fusion reaction has a greater specific impulse, or with advanced fuels, the mass produced is the same thing, near μg. To the contrary, in micro fusion, since to have a great DT yield, a greater amount of Pu/U is needed, beyond to be more clean or nuclear fission defects in the exhaust and is easier to control in the reactor or reaction vessel.

To increase velocity, many units are accopled to the ship, yet is far from 0.1 c, or are need 60 units of 5 mg burning 30%, the same analysis for DHe3 but with less nuclear fuel mass, enlarging the traveled distance with the same amount of mass stored, or DD reactions initiated by He3 reactions that have a specific impulse of 1.8 times more than DHe3 reactions second in the following equation (3), but are not neutron free.
Iₛₚ=√(1/g)(2γ/γ−1)(R/M)T (3)

When R, g, and T are present in S.I. units, the advantage in using neutron free nuclear fuels like DHe3, He3-Li6, D-Li6, initiated or not by tritium in propulsion case, where this nuclear reaction has charged particles in the products of these reactions and are neutron free and being well chosen will proportion a chain reaction, free of neutrons, making only charged particles, while aiding the thrust. With this it will remove the weighted neutron shield, but in every one of these reactions has a chain reaction, since some reactions produce neutrons in their reactions and can happen with same probability needing neutron shields, but less thick. The protection shield can be removed, since the elements can be efficiently produced in another place at the beginning of the fusion or fission reaction that produces this element, remaining, in this case, the first wall, the protector shield and the magnetic field. Or in the case of DHe3 without being catalyzed the fuel of analogous configurations right below is detonated by the proposed driver, needing the first wall and the magnetic field, where the material needed for the fuel is produced in the reactor(s) together with the mean driver, that is the dry system with the present technique can support advanced fuels without extreme risk.

In this reaction DT-DHe3-DD, or the DT reaction initiate DHe3 reaction that produces enough temperature to initiate the DD reaction, that has the better specific impulse to produce a better ignition temperature.

In this case, not needing the production shield in the motor, want to have a means to produce D and He3 that can be obtained by laboratory fusion reactions inside the spaceship, therefore, producing tritium that decays in twelve years in He3, therefore, producing deuterium, if the case.

For travelers inside the solar system, where Pu is needed in the driver formation, the Pu can be stored in the optimized target case and be of 0.01 g and in the center 1 μg of DT, or until solar system periphery are needed by each fire in a second (can be more, if needed) and by a reactor or beam formation 279 kg/year and 31.6 kg/year of DT, without taking into account the fuel mass needed in the exhaust, maintaining the fission mass and raising the fusion mass to gain better fission burn, producing better energy to drive generation, since only 0.01 g of micro fission produces 0.01 tons of TNT, likewise 36 MJ, twenty times more than energy, produced by 192 NIF laser and 1 kg (more explosive version) to send in five years against an asteroid and likewise has a specific impulse near z-pinch LMTL model from order of magnitude of the evaporated material is a tenth of a kilogram, and the velocity, in this case, is 30 km/s and 50% of fuel burn, and in the present invention with 1 kg waste in the driver elaboration. With mini fission in a model lighter than W54, the velocity is less than 26 km/s, or using mini fusion with an artifact called a “baseball bomb” weighing 10 kg, initiated by plastic explosive lenses or with a lighter model weighing 1 k, if one day it will be possible to initiate fission with 1 kg of chemical explosive. The ideal will be 10/50 g of high explosive micro lenses initiated by a laser and detonate 10/50 g of P_{U}/U since the quantity of high explosives is equal to quantity of nuclear fuel to be detonated and relaxes the need for a fast and efficient coupling between the release of explosive energy and the fuel pellet, or the same with nuclear macroscopic detonations, if the planetary travel is rapidly viable. With 1 g of Pu/U to beam formation and 1 g of DT or another nuclear fuel and 10% of fuel burn, the velocity is 258 km/s. The mass waste in the driver formation has to be less or equal to the mass waste in the exhaust, or the mass in the velocity equation (1) is the sum of three masses, since they fall in line 3 in the example of Table 2, where the velocity is low. In the same case, but with 50% of fuel burn, the velocity can be 573 km/s and in the worst case 1% of fuel burn is 82 km/s. Table 2 illustrates that the values are the same for 1 g, 5 mg, or 100 mg, the change in velocity depends in burn percent in each case. Then with 10 mg of P_{U}/U is above the cylinder mass and the energy needed in the driver to initiate the reaction is near 100 kJ. If the question is lowering mass, then the ideal in the driver for propulsion by the present method is the fuel mass near 0.001 g of P_{U}/U that produces 7.4 MJ being needed 10 kJ of energy in the driver and this driver now is less than 10 MJ which begins a DT reaction after the DHe3 reaction, since a driver that initiates DHe3 combustion only is out of cogitation or scaling in the present invention method. In a cylindrical fuel case, the target is made of shells in the reactor, and the fuel ray is the same size as the ray spot driver with or without tamper, pusher, and magnetic field. The cylindrical geometry is preferable to mount around the cylindrical target the capsule with the cylinders that will be evaporated by the target explosion, but is possible with spherical and conical fast ignition targets with direct and indirect drive and the laser cylinders that will cause the laser to launch separately from the targets.

This is an advantage, since it will now be possible to model and test the system without waiting fifteen or fifty years.

In this case, it is not possible to obtain enough fuel by laboratory reactions in the ship, and has to be an option between the fuels, where the candidates will be DHe3 catalyzed reactions, having tritium that lowers fuel ignition temperature beyond the exhaust vessel is needed, the protector shield or the option being by DT detonations that generate a progressive shock wave that will arrive DHe3 cold fuel, from this macro nuclear fuel target, this model is adequate for travelers inside the solar system, where there is not a great need for storage of fuel since it can withdraw the production remaining in the first wall, the protector shield (tritium) and the magnetic field where this mass compensates the specific impulse, since it is in the solar system, then the exhaust can support this high fuel temperature of 600 million Celsius degrees.

The driver intensity is 10 MJ for pure advanced fuels, that is without Uranium or DT, the intensity of the present driver is related to micro explosions that will arrive at the cylinder, and will be modeled by the before-mentioned method, using fission/fusion according to Table 1.

The DT target mass in the micro fusion case is near ⅕ μg through LTI target where the order of magnitude need in the driver is in the kJ less than 550 kJ needed by mini fission method to produce 2.10⁹ J that is enough to initiate DT reactions and arrive at the cylinders generating beams in the 32/320 MJ enough to initiate advanced fuels like T_{X}DHe3 and others advanced with tritium or by fast ignition method targets and by direct or indirect driver.

The motor has magnetic fields in the exhaust vessel that make it possible to raise the dimensions of the nuclear fuel target, since raising the mass and, consequently, the density, lowers the energy driver, using the lower temperature ignition (LTI) target in the experiments to energy production or with fast ignition methods in conical targets. The DT seed reactions are enough to initiate DHe3 reaction that is in the cold fuel in the constitution of microspheres.

Like the drivers proposed in the present invention are in the x radiation, the target constitution (spherical or cylindrical) in the exhaust is plastic, DT, and DHe3 or T_{X}DHe3.

The nuclear fuel target injection system in the reactor in the case of micro fusion reactions is electrodynamics that is adequate to inject low mass target, and in fission/fusion micro reactions where the target has a capsule with two or more cylinders having, therefore, a reasonable mass, by electromagnetic means, since inside the capsule there is a very small quantity of iron to facilitate the injection by electromagnetic accelerator when a slingshot capsule is accelerated and launches the target fuel. The accelerator capsule, levitates like a superconductor train without touching the super conductor track, that is braked and the target follows by inertia. The target tracking system uses cameras and detectors like the following. In the exhaust, the targets can be illuminated by direct and indirect drive and the adequate means is by a gas trigger when the work gas is helium or another light gas. This method avoids interaction with the exhaust magnetic field, attaining the targets' velocity of 500 m/s requiring a gas reservoir and a valve control, and a cryostat that will store and load the target inside a cylindrical tube of gas. From this point, the target will go by inertia when trajectory is traced by photodiodes or a laser and cameras are positioned along the cylindrical tube of the gas contention and will send information to a computer that calculates the distance and positioning from the exhaust center, since the same has cameras and photodiodes diametrical opposed, sending signals and traces the tube with cameras. The target producer system, by polymerization, makes resistant polymer and permits automatic production and stores it in a cryostat and is connected to the system injection cryostat, closing the cycle.

The exhaust vessel diameter is to support micro explosions between 1 ton/800 tons of TNT that is between 3.5/35 meters. Traveling to the stars requires a motor using advanced fuels with a maximum reduction in the shields and a gun driver making the fuel and the driver by inertial fusion confinement.

Not being possible to initiate or detonate at same time, 50/100 g of DHe3 or T_{X}DHe3 has to be used four reactors or space of confinement around the exhaust vessel detonating inside the exhaust four reactions or more at the same time, or four semi hemispheres where each center has the same distance from the exhaust center with the advantage to scale the specific impulse since in each hemisphere center many targets can be detonated in a second. Choosing the first wall material, like Kevlar, that is light and resistant, or carbon-carbon composite alloy that due to a high melting point (1500°) gives to the material a high-temperature resistance proposed to the nuclear rubbish container being the support structures of Kevlar or steel and the magnetic field shield being of high-temperature superconductors like a mercury derivative and a cupric oxide with variations in oxygen concentration when, in some cases, adds thallium or strontium obtaining metallic ceramics of high-temperature superconductivity reducing the need of immersion tanks containing helium or refrigerated nitrogen (in DHe3 when reduced in mass can compensate this hypothesis, beyond high specific impulse) or copper derivatives and ceramic materials producing magnetic fields near 60 T or more, or superconductivity binary alloy of niobium that has the advantage to be transformed in thread and produces a high magnetic field, or ambient superconductors when the candidate is He3 superfluidity will be a lighter system with a first-wall refrigerator and a magnetic field producing a test probe of low cost and carrying the needs.

Simplifying: what is needed is a nuclear fuel, where happen low intensity (scaling, if needed) nuclear fission/fusion reactions in a place (reactor or reaction vessel) destined to produce an energetic beam that by one's turn will initiate in the exhaust thermonuclear fusion micro reactions of fuels, according to the finality of the motor near the solar system periphery (DT, DT-DHe3, T_{X}DHe3) or beyond (DHe3, T_{X}DHe3, T_{X}Li6, DT-DHE3-DD) and the beam is directed to these fuels to initiate nuclear reactions and combustion and a magnetic field that will repel (expel) the hot plasma, and is a means to produce and inject the nuclear fuel, without requiring an enormous stored volume.

The invention will be better understood with the following detailed description in consonance with annex figures.

### BRIEF DESCRIPTION OF THE DRAWINGS

FIG. 1 represents one unit and a general motor vision with a driver system.

FIG. 2 represents one unit and a lateral motor vision and the disposition of energetic beams around the exhaust vessel with a hemispherical shape, in case of direct drive and corona formation with cylindrical and spherical target and illustrates many processes.

FIG. 3 represents one unit and a lateral motor vision and the disposition of energetic beams with indirect and direct drive with two-sided illumination, and the intensity of explosions the same as in FIG. 2, for advanced fuels.

FIG. 4 represents the same situation as in FIG. 3, but with explosions between 1 ton/2 ton TNT to produce the x-ray or gamma-ray laser beam with a cylindrical contention vessel.

FIG. 5 represents the same situation as in FIG. 4, but with a spherical vessel of contention.

FIG. 6 represents the same situation as in FIG. 5, but with 5 tons of TNT, or less and a hemispherical vessel of contention, generating, or not, a primary exhaust and the beam for advanced fields.

FIG. 7 represents the capsule that contains the target and the cylinder rod for x-ray laser generation.

FIG. 8 represents the cylinder that will contain micro explosions, in many cases.

FIG. 9 represents the set of coils that generate the magnetic field in the capsule that will collaborate with micro mini explosions.

FIG. 10 represents the reactor target in a cylindrical shape to a beam formation.

FIG. 11 represents the reactor target in an ellipsoidal shape to a beam formation.

FIG. 12 represents the exhaust target in a cylindrical shape.

FIG. 13 represents the exhaust target in a spherical shape.

FIG. 14 represents the reactor target and the shields in a cylindrical or spherical geometry.

FIG. 15 represents the same situation as in FIG. 14, but with a high micro magnetic field from capacitor banks or other processes.

FIG. 16 represents the reactor target with a fast ignition in a cylindrical or spherical geometry.

FIG. 17 represents the exhaust target injection system.

### DETAILED DESCRIPTION OF THE INVENTION

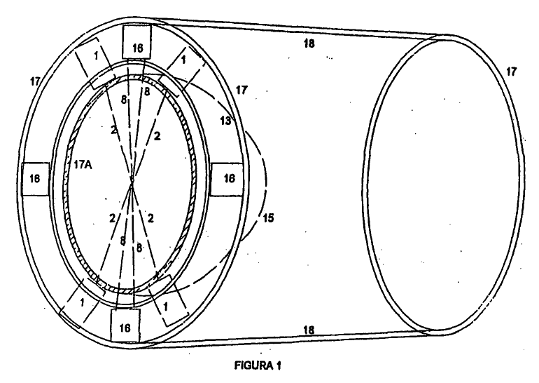

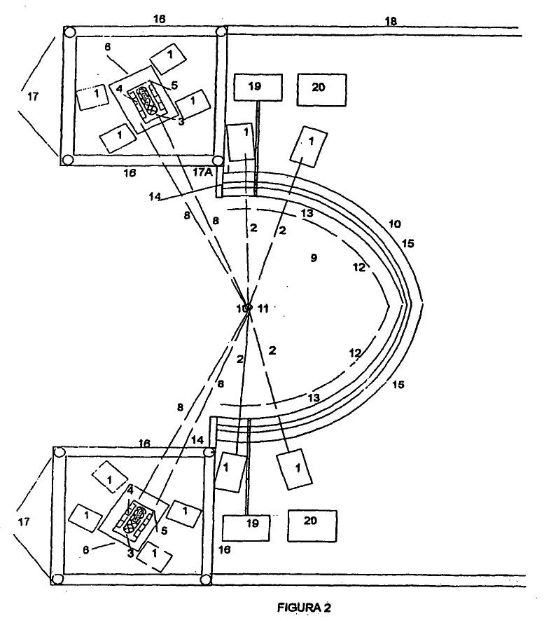

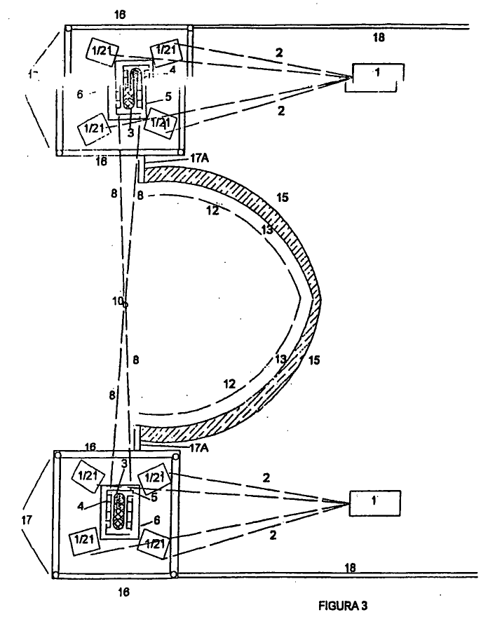

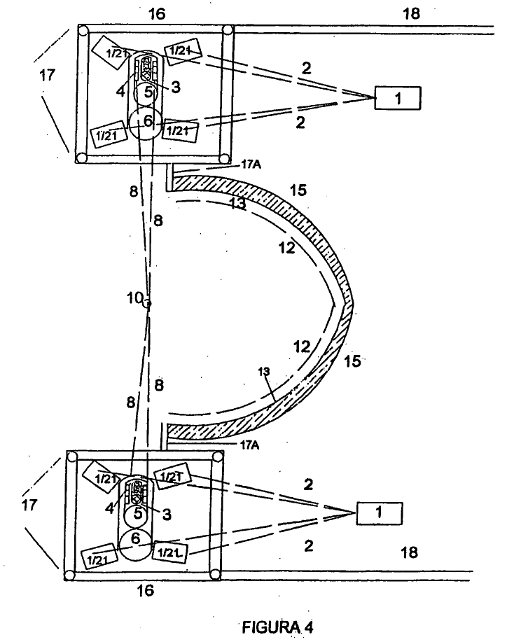

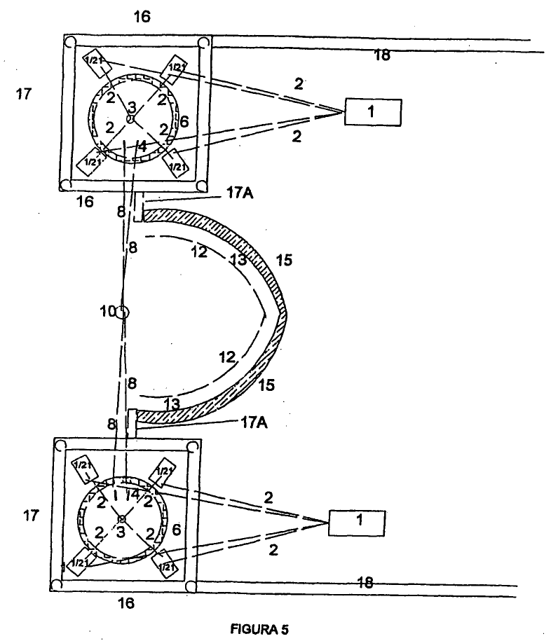

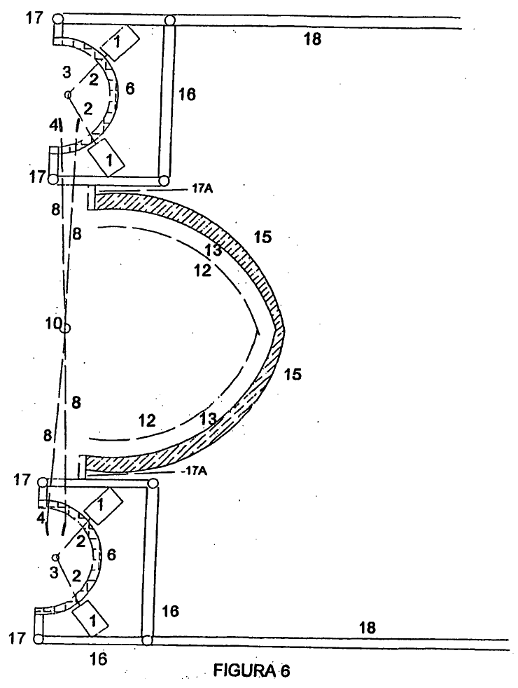

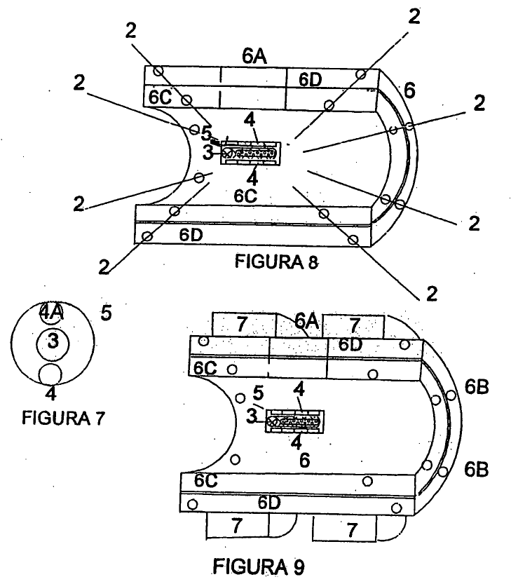

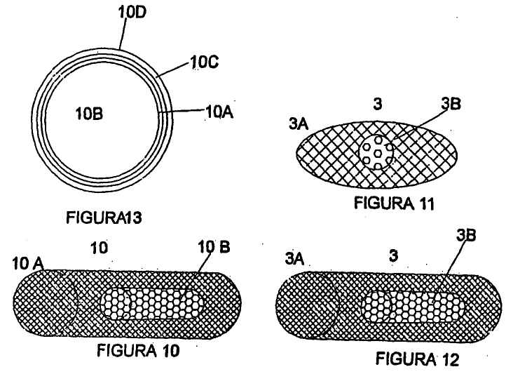

To agree with these figures and in the details, the present invention “PROPULSION MOTOR, PROCESSES AND BEAMS FROM THERMONUCLEAR FUSION MICRO REACTIONS” in conformity with FIG. 1, the motor is constituted of two rings (17), linked between it by a sustentation bar (18) making motor external structure (17,18) in the exhaust (13,14,15), linked to a third ring (17A) and the mean driver reactor room (16) and in number of 4, in the optimized case that is by our turn linked to motor external structure (17), where one or two lasers are operational and two or three are maintained in reserve for possible repairs. We can observe the driver system (1) placed into motor external structure (17,18) and externally to exhaust (13,14,15) that are illuminated by conventional laser or particles beams (2) and generate the energetic beam (8) directed to spherical target (10) inside the exhaust (13,14,15). How are three shields, and in the case of neutronic reactions, like DT, DTHe3, etc. In this case, the micro explosions are between 0.02 to 0.1 tons TNT producing in the beam 32 MJ to 720 MJ with explosion diameters between 42 cm to 1.97 m corresponding to cylinder or spherical diameter (6) that will retain the micro explosions illustrated in FIG. 2, as well as the fuel target (3) contained in a capsule (5) where inside is the cylinder rod (4) for beam formation (8) that will be arrived at by x-radiation from each micro explosion that is initiated by the driver system (1). Made the energetic x-ray beam (8) by thermonuclear reactions, this will detonate the target fuel (10) inside the exhaust (13,14,15) where the line of force from magnetic field (12) is to avoid that the hot plasma touch the exhaust wall (13). This neutronic fuel (10) is injected by the production and injection system (19,20) that can be placed in an extra room (16) such for fuel manufacturing (3,10) like injecting it into the exhaust (13,14,15) like in the reactor (6A). In FIG. 3, the same before situation, but, in this case, the target (10) is cylindrical or spherical for fast ignition by direct drive, or by indirect drive with illumination by both sides (8), where the driver system (conventional laser or particle beams (1) are placed out of room (16) and inside the motor external structure (17,18) and directed by mirrors (21) to the target (3) with the intention of advanced fuels detonation and with low tritium proportion or DTHe3 in target (10). In FIG. 4, with the change from FIG. 3, is the system of micro explosions retention, needs a cylinder (6) with a greater diameter 3.5 m since it is to support greater detonations from 1 to 2 tons of TNT. In FIG. 5, the change is the contention vessel shape that is spherical (6) where the fuel (3) after detonation by any processes (laser, particle beams, z-pinch, MTF, anti-matter particles) will reach the cylinder (4) beam formation that is vaporized when attained by x-rays from fuel target (3) detonation that can be cylindrical, spherical, or ellipsoidal in fission case, that is in the micro Centurion/Halite. In FIG. 6 what changes is the intensity of detonation that can reach 5 tons of TNT when the system of contention is changed by another vessel in the exhaust type that is the best way to disperse the micro explosion from fuel target (3) that will arrive at the cylinder rod (4) generating the energetic beam (8). In this case, the vessel diameter is near 5.6 m that of magnetic field (7) and can be reduced to 4 m, by using a shock absorber where the fuel mass (3) if micro fission is near 1 to 3 kg, and by micro fusion between 10 μg/10 mg of DT, in mini fission 10 g to 1 kg of P_{U}/U (without chemical explosive mass, or initiated by laser, or micro mini explosive lenses initiated by laser) and in mini fusion like an artifact called a “baseball bomb” with a mass of 10 kg (the ideal is much less), generated in the beam 21 GJ that is enough to initiate any advanced fuel, causing this project to withdraw from theory, although with values between 0.02 to 0.1 g of P_{U}/U with deuterium in the center, it is a great improvement and to withdraw this project from theory, since the x-ray laser energy is from 7.2 MJ to 720 MJ that has conditions to detonate T_{X}DHe3, with less ignition temperature than DHe3, needing the protector shield (14) but less thick, since the present laser/particle beams produced the implosion or compression and moments before implosion to bring into action a magnetic field that avoids loss of fuel entropy as illustrated in FIGS. 1-3, making viable the present project. In this case, to send an aerolite with much mass and velocity to repel an asteroid with much mass and breakable constitution and by fission explosions to produce the beam with 1 kg of P_{U}/U or less (10% of light W54 explosions), by mini fusion to produce the beam explosions with the dimensions of a “baseball bomb,” and agree with the show numbers, that micro fission fusion produces first the beam with the lowest mass quantities illustrated in Table 1, or calculations above, would be possible without the need of extreme solutions, but feasible, or to model and demonstrate the system. In FIG. 7, the capsule (5) used in the micro fission or micro fusion, when the beam (2) arrives the fuel (3), that after micro explosions, the x-rays from micro explosions arrive at the cylinder (4) that has in the extremity pointed to the target (10) a material (4A) transparent to x-radiation the same used in the cylinder or low Z material and in another extremity from cylinder (4) a material opaque to x-radiation (4B) or high Z material producing in this manner the lasing medium to nuclear micro bomb pumped x-ray laser, since it is by fission or fusion. FIG. 8 illustrates the capsule (3,4,5) arriving at the beams (2) that pass by orifice (6B) reaching the target (3), the capsule (3,4,5) that is injected by orifice (6A) where the wall is thick, in this case, is 10 cm of steel (6C) with a shell of lead in 20 cm to retain the neutrons or carbon-carbon composite (6D) for the neutrons that do not reach the coil (7) that will produce the magnetic field. A particular case is when the energetic beam is only a hollow particle beam (2) perpendicular to the target axis (3) having the configuration illustrated in FIG. 15 and an axial magnetic field (7) that will act slightly before implosion, being subsequently of for the micro explosions arrive at the cylinder (4) producing the laser shown in FIG. 9 or the cylinder (4) launched separately from the target (3) by another orifice in (5) and (6). In FIG. 10, the target (10) in cylindrical shape is used in the exhaust (13,14,15) as (10A) is DT and (10B) is DHe3 or another neutron-free fuel by direct drive with the beam (8). FIG. 11 illustrates the fuel (3) of ellipsoidal shape to make the beam (8) produced from P_{U}/U (3A) e DT (3B), that is compressed in both sides by high explosives to a sub critical mass, as illustrated in FIG. 12, the fuel (3) from solid cylindrical shape containing P_{U}/U (3A) e DT (3B), and a normal beam. A particular case from cylindrical geometry is when adding a gold shell and is illuminated by a pettawatt laser in both sides producing x-rays and a convergent cylindrical wave for compression. In FIG. 13, the target (10) is used in the exhaust (13,14,15) and is constituted from plastic (10D) aluminum, gold, or tantalum (10C) and DT_{X} (10A) like a micro explosion seed and (10B) the main fuel that can be DHe3, T_{X}DHe3, DHe3-DD, or D-Li6.

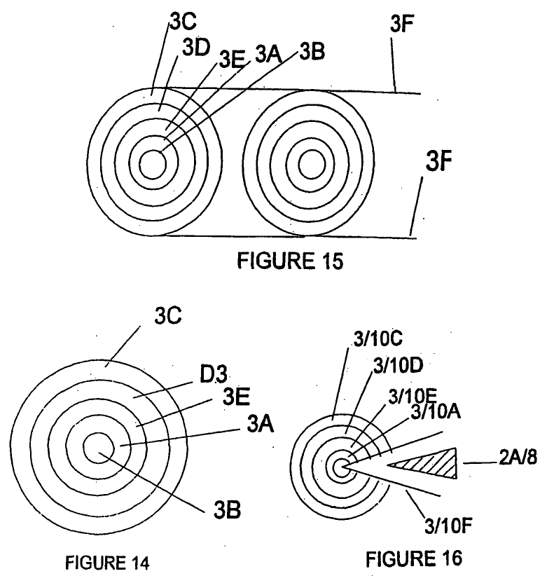

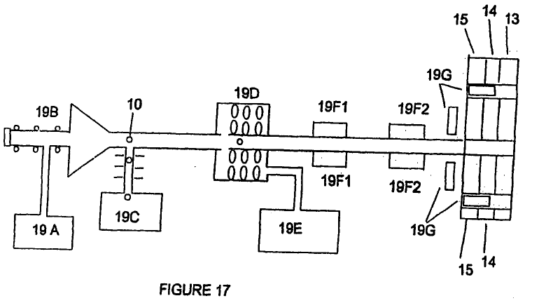

FIG. 14 illustrates the basic configuration illustrating how to design the target (3) of nuclear fuel in the reactor or vessel of contention (6) to enhance the nuclear explosion and x-radiation after explosion. According to the explosive lenses method, the shell (3C) is relative to micro mini explosive lenses (from mg to g of mass) initiated by a laser or classical detonators external and around, and the shell (3D) is the tamper that, in this case, has a double finality, like a compound of an explosive lense that converts the diverging detonation wave in a converging shock wave, beyond the model in terms of radiation, the explosion products like in W71 gold was used to enhance x-radiation and like a tamper, or thallium, or tantalum to produce gamma radiation in the 1200 MeV from the nuclear micro explosion. The shell (3E) is relative to the neutron reflector and may be of beryllium or uranium and the shell (3A), the fissile material, and (3B), the DT, to boost fission. A particular case is when the target (3) is arrived by a pettawatt laser, then the shell (3C) is gold when vaporized gene rate x-rays, the shell (3D) is the pusher being plastic or other low Z material, the outer shells are the same in cylindrical or spherical geometry. In FIG. 15, the external shell of explosive lenses (3C) can be substituted by a z-pinch system, wire array z-pinch, or MTF, with the magnetic field (3C) obtained by superconductor of millimeter size, fed by a capacitor bank that is linked by means of transmission lines (3F) to the target set (3A, 3E, 3D, 3C) or without some shells, according to each case. In FIG. 16, the basic target (3,10) configuration for fusion fast ignition concept is used, as well as for fuel (3) in the reactor (6) or for fuel (10) in the exhaust (13,14,15) in cylindrical or spherical geometries by direct drive or indirect drive, being (3/10F) the gold cone for the ignitor, in each case. In reactor (6), or vessel of contention, the target (3) is bombarded by a pettawatt laser (2A) or ignitor, and the external shell (3/10C) by a laser or particle beams (2) for the compressor. In exhaust (13,14,15), the compressors are laser and particle beams (2) and the present invention beams (8) for fast ignition with the mean fuel (10), advanced fuels. By indirect drive because lasers can be focused to heat very small spots, even relatively small lasers can achieve high temperatures in hohlraums. For this reason, normal cylindrical hohlhaums (3,10) with spherical target inside of the cylinder, are bombarded from both sides with compressor beams (2) that deposit their energy in one side and the ignition beams (2A,8) deposit their energy in another side with the gold cone linked directly to the target sphere inside the cylinder. Many other configurations are possible. FIG. 17 illustrates the injector system (19) from the exhaust (13,14,15) by a gas trigger that is constituted from a gas reservoir (19A), and a control valve (19B) to control pressure, temperature, etc., inside the initial tube (19) and a cryostat (19C) to store the targets (10) that will be injected and produced in the production system (20), and remove the gas to a reservoir (19D) by means of suction bombs (19E) linked to the reservoir (19D). The target (10) trajectory is traced by detectors or photodiodes or laser diodes (19F1 e 19F2) and a camera system (19G) and is transmitted to a computer that calculates the target position.

Finally, the injector system (19) for nuclear fuel (3) is by electromagnetic or electrodynamics means, since inside the capsule (5) can be placed very small iron fragments to facilitate in the injection system (19) and positioning in the place were haven't the cylinder rod (4). The production system (20) of fuel (3) to reactor room (6) in case of micro fusion is by cryogenics and of fuel (10) is by polymerization and stored in a cryostat that is later linked in the injector system (19).

1) “PROPULSION MOTOR, PROCESSES AND BEAMS FROM THERMO NUCLEAR FUSION MICRO REACTIONS” being the motor CHARACTERIZED by, to hold two cylindrical rings (17) that is fixed between it by cylindrical supports of sustentation (18), and a third cylindrical ring (17A) that will sustain the reactor room (16) of the mean drive (8) that is placed between the two terminal rings, that by own turn are fixed to the cylindrical ring (17) that sustain the exhaust wall (13) of shells (13,14,15) in hemispherical shape to protect the magnets (coils) (15) being the driver system (1) placed behind magnets (15) and inside reactor room (16).

2) “PROPULSION MOTOR” according to claim 1, characterized by the driver system (1) parallel placed to the vertical axis from exhaust (13,14,15) and the driver system (1) inside reactor room (16) substituted by mirrors (21) that will direct the beams (2) to arrive at the target (3).

3) “PROPULSION MOTOR,” according to claim 1, characterized by the exhaust first wall (13) constituted from carbon-carbon composite and Kevlar.

4) “PROPULSION MOTOR,” according to claim 1, characterized by the exhaust first wall (13) constituted from carbon-carbon composite and graphite.

5) “PROPULSION MOTOR,” according to claim 1, characterized by the magnet (15) constituted of copper and ceramic material.

6) “PROPULSION MOTOR,” according to claim 1, characterized by the super conductor coils (15) constituted from Nb₃Sn.

7) “PROPULSION MOTOR,” according to claim 1, characterized by the super conductor coils (15) constituted from Nb₃Al.

8) “PROPULSION MOTOR,” according to claim 1, characterized by the super conductor coils (15) constituted from HgBa₂Ca₂Cu₃O_{8.33} with Ti and with variations of oxygen concentration.

9) “PROPULSION MOTOR,” according to claim 1, characterized by the exhaust (13,14,15) internal diameter able to support micro/mini explosions from 1 ton/to 800 tons of TNT equivalent.

10) PROCESSES AND BEAMS FROM THERMONUCLEAR FUSION MICRO REACTIONS,” according to claim 1, characterized by hold a system of energetic beams (2) that cross a recipient (6), like a reactor, arriving at target (3) of nuclear fuel producing nuclear micro reactions, arriving at the inner capsule (5) containing cylinder rod (4) having in their extremity lenses (4A) transparent to x-radiation, that will produce the energetic beam (8) after arriving at target (10) constituted from nuclear fuel producing fusion micro reactions (11), that generate very small charged particles that require a reflector magnetic field (12) in the external vessel, having a protector shield (14) to neutrons from each nuclear explosion, where the fuel (3,10) are injected by injector system (19) and production system (20), beginning a new cycle.

11) PROCESSES AND BEAMS FROM THERMONUCLEAR FUSION MICRO REACTIONS,” according to claim (10), characterized by the energetic beam (2) constituted from photons.

12) PROCESSES AND BEANS BEAMS FROM THERMONUCLEAR FUSION MICRO REACTIONS,” according to claim (10), characterized by the energetic beam (2) constituted from particles of light elements of periodic table.

13) PROCESSES AND BEAMS FROM THERMONUCLEAR FUSION MICRO REACTIONS,” according to claim (10), characterized by the energetic beam (2) constituted from heavy elements of periodic table.

14) PROCESSES AND BEAMS FROM THERMONUCLEAR FUSION MICRO REACTIONS,” , REACTIONS,” according to claim (10), characterized by the energetic beam (2) constituted from neutrons and anti particles produced by laser.

15) PROCESSES AND BEAMS FROM THERMONUCLEAR FUSION MICRO REACTIONS,” according to claim (10), characterized by the reactor vessel (6) of cylindrical shape with holes (6A) to channel beam (2) arriving at the target (3) of nuclear fuel with the help of coils (7) constituted from NbTi.

16) PROCESSES AND BEAMS FROM THERMONUCLEAR FUSION MICRO REACTIONS,” , according to claim (10), characterized by the reactor vessel (6) of cylindrical shape with holes (6A) to channel beam (2) arriving at the target (3) from nuclear fuel, with the help of coils (7) constituted from copper aluminum and silver.

17) PROCESSES AND BEAMS FROM THERMONUCLEAR FUSION MICRO REACTIONS,” , according to claim (10), characterized by the reactor vessel (6) of cylindrical shape with holes (6A) to channel the beam (2) arriving at the target (3) from nuclear fuel, with the help of coils (7) constituted from copper aluminum and niobium.

18) PROCESSES AND BEAMS FROM THERMONUCLEAR FUSION MICRO REACTIONS,” according to claim (10), characterized by the reactor vessel (6) of cylindrical shape with holes (6A) to channel the beam (2) arriving at the target (3) from nuclear fuel producing the energetic beam (8) arriving at the target (10) of nuclear fuel.

19) PROCESSES AND BEANS BEAMS FROM THERMONUCLEAR FUSION MICRO REACTIONS,” , according to claim (10), characterized by the reactor vessel (6) of hemispherical shape with holes (6A) to channel the beam (2) arriving at the target (3) from nuclear fuel producing the energetic beam (8) arriving the target (10) of nuclear fuel across hole (6B).

20) PROCESSES AND BEAMS FROM THERMONUCLEAR FUSION MICRO REACTIONS,” according to claim (10), characterized by the reactor vessel (6) has a shield of steel 10 cm/20 cm of thick (6C) and lead (6D) to protect the magnets (7) and magnets (15).

21) PROCESSES AND BEAMS FROM THERMONUCLEAR FUSION MICRO REACTIONS,” according to claim (10), characterized by the reactor vessel (6) has a shield of steel 10 cm/20 cm thick (6C) and carbon-carbon composite (6D) to protect the magnets (7) and magnets (15).

22) PROCESSES AND BEAMS FROM THERMONUCLEAR FUSION MICRO REACTIONS,” according to claim (10), characterized by the cylindrical capsule (5) containing inner cylinder rod (4) of millimeter dimension constituted from aluminum and lenses (4A) of light Z elements.

23) PROCESSES AND BEAMS FROM THERMONUCLEAR FUSION MICRO REACTIONS,” according to claim (10), characterized by the cylindrical capsule (5) containing inner cylinder rod (4) of millimeter dimension constituted from tungsten and lenses (4A) of light Z elements.

24) PROCESSES AND BEAMS FROM THERMONUCLEAR FUSION MICRO REACTIONS,” , according to claim (10), characterized by the cylindrical capsule (5) containing inner cylinder rod (4) of millimeter dimension constituted from gold and lenses (4A) of light Z elements.

25) PROCESSES AND BEAMS FROM THERMONUCLEAR FUSION MICRO REACTIONS,” according to claim (10), characterized by inside spherical reactor vessel (6) cylinder rod (4) separately from target (3) of millimeter dimension constituted from aluminum and lenses (4A) of light Z elements.

26) PROCESSES AND BEAMS FROM THERMONUCLEAR FUSION MICRO REACTIONS,” , according to claim (10), characterized by inside spherical reactor vessel (6) cylinder rod (4) separately from target (3) of millimeter dimensions constituted from tungsten and lenses (4A) of light Z elements.

27) PROCESSES AND BEAMS FROM THERMONUCLEAR FUSION MICRO REACTIONS,” , according to claim (10), characterized by inside spherical reactor vessel (6) cylinder rod (4) separately from target (3) of millimeter dimension constituted from gold and lenses (4A) of light Z elements.

28) PROCESSES AND BEAMS FROM THERMONUCLEAR FUSION MICRO REACTIONS,” according to claim (10), characterized by inside hemispherical reactor vessel (6) has cylinder rod (4) separately from target (3) of millimeter dimensions constituted from aluminum and lenses (4A) of light Z elements.

29) PROCESSES AND BEAMS FROM THERMONUCLEAR FUSION MICRO REACTIONS,” according to claim (10), characterized by inside hemispherical reactor vessel (6) has cylinder rod (4) separately from target (3) of millimeter dimensions constituted from tungsten and lenses (4A) of light Z elements.

30) PROCESSES AND BEAMS FROM THERMONUCLEAR FUSION MICRO REACTIONS, ” according to claim (10), characterized by inside hemispherical reactor vessel (6) has cylinder rod (4) separately from target (3) of millimeter dimensions constituted from gold and lenses (4A) of light Z elements.

31) PROCESSES AND BEAMS FROM THERMONUCLEAR FUSION MICRO REACTIONS,” , according to claim (10), characterized by the target (3) has the cylindrical shape and constituted of uranium/plutonium from 0.001 g to 0.1 g and μg of DT in the center of cylinder (3) happening fission and fusion micro explosions from 0.01 to 0.1 tons of TNT equivalent contained in cylindrical reactor vessel (6) from 42 cm to 1.90 m in inner diameter.

32) PROCESSES AND BEAMS FROM THERMONUCLEAR FUSION MICRO REACTIONS,” according to claim (10), characterized by the target (3) has the cylindrical shape and constituted of uranium/plutonium from 1 g/2 g and μg of DT in the center of cylinder (3) happening fission and fusion micro explosions from 1 ton to 2 tons of TNT contained in a cylindrical reactor vessel (6) from 3.5 m to 4.5 m in inner diameter.

33) PROCESSES AND BEAMS FROM THERMONUCLEAR FUSION MICRO REACTIONS,” according to claim (10), characterized by the target (3) of the spherical shape constituted of uranium/plutonium from 0.001 g to 0.1 g and μg of DT in the center of sphere (3) happening fission and fusion micro explosions from 0.01 to 0.1 tons of TNT contained in spherical reactor vessel from 49 cm to 1.90 m in inner diameter.

34) PROCESSES AND BEAMS FROM THERMONUCLEAR FUSION MICRO REACTIONS,” according to claim (10), characterized by the target (3) of the spherical shape constituted of uranium/plutonium from 1 g to 2 g and μg of DT in the center of sphere (3) happening fission and fusion micro explosions from 1 ton to 2 tons of TNT contained in spherical reactor vessel (6) from 3.5 m to 4.5 m in inner diameter.

35) PROCESSES AND BEAMS FROM THERMONUCLEAR FUSION MICRO REACTIONS,” according to claim (10), characterized by the target (3) of the spherical shape constituted of uranium/plutonium from 3 g to 5 g and μg of DT in the center of sphere (3) happening fission and fusion micro explosions from 3 ton to 5 tons of TNT contained in hemispherical reactor vessel (6) from 5.0 m to 7.0 m in inner diameter.

36) PROCESSES AND BEAMS FROM THERMONUCLEAR FUSION MICRO REACTIONS,” according to claim (10), characterized by the target (3) of ellipsoidal shape and constituted of uranium/plutonium from 0.001 g to 0.1 g and μg of DT in the center of ellipsoid (3) contained in a cylindrical/spherical reactor vessel (6) from 49 cm to 1.90 m in inner diameter.

37) PROCESSES AND BEAMS FROM THERMONUCLEAR FUSION MICRO REACTIONS,” according to claim (10), characterized by the target (3) of ellipsoidal shape and constituted of uranium from 1 kg to uranium/plutonium and μg of DT in the center of ellipsoid (3) happening fission and fusion micro explosions contained in a spherical/hemispherical reactor vessel (6).

38) PROCESSES AND BEAMS FROM THERMONUCLEAR FUSION MICRO REACTIONS,” according to claim (10), characterized by the target (3) of cylindrical/spherical/ellipsoidal/shape from 0.001 g to 1 kg of uranium/plutonium and μg of DT in the center of target (3) happening fission and fusion micro explosions initiated by energetic beans beams (2) (laser/particles).

39) PROCESSES AND BEAMS FROM THERMONUCLEAR FUSION MICRO REACTIONS,” according to claim (10), characterized by the target (3) of cylindrical/spherical/ellipsoidal shape from 0.001 g to 1 kg of uranium/plutonium and μg of DT in the center of target (3) happening fission and fusion micro explosions initiated by chemical high explosives.

40) PROCESSES AND BEAMS FROM THERMONUCLEAR FUSION MICRO REACTIONS,” according to claim (10), characterized by the target (3) of cylindrical/spherical/ellipsoidal shape from 0.001 g to 1 kg of uranium/plutonium and μg of DT in the center of target (3) happening fission and fusion micro explosions initiated by micro/mini explosives lenses initiated by lasers.

41) PROCESSES AND BEAMS FROM THERMONUCLEAR FUSION MICRO REACTIONS,” according to claim (10), characterized by the target (3) in cylindrical/spherical shape and constituted from μg to mg of DT happening micro/mini nuclear fusion explosions initiated by energetic beans beams (2) (laser/particles).

42) PROCESSES AND BEAMS FROM THERMONUCLEAR FUSION MICRO REACTIONS,” according to claim (10), characterized by the target (3) in cylindrical/spherical shape and constituted from μg to mg of DT happening micro/mini nuclear fusion explosions initiated by high chemical explosive, MTF, wire array z-pinch, fast z-pinch with magnetic field of, after nuclear explosions.

43) PROCESSES AND BEAMS FROM THERMONUCLEAR FUSION MICRO REACTIONS,” according claim (10), characterized by the target (3) in cylindrical/spherical geometry having the shells (3C) of high explosive micro/mini lenses initiated by lasers, the tamper shell (3D), the neutron reflector shell (3E), the fission shell (3A) and the fusion shell (3B) with variations in shells constitution, according with driver (2) applied z-pinch, fast z-pinch, array z-pinch, MTF, beam of anti particles from CPA laser impact against heavy elements.

44) PROCESSES AND BEAMS FROM THERMONUCLEAR FUSION MICRO REACTIONS,” according to claim (10), characterized by the target (3) the tamper shell (3D) constituted from gold in micro fission explosions and the others shells the same.

45) PROCESSES AND BEAMS FROM THERMONUCLEAR FUSION MICRO REACTIONS,” according to claim (10), characterized by in the target (3) the tamper shell (3D) constituted from tantalum in micro fission explosions and the others shells the same.

46) PROCESSES AND BEAMS FROM THERMONUCLEAR FUSION MICRO REACTIONS,” according to claim (10), characterized by the targets (3,10) constituted from shells (3/10A, 3/10B, 3/10C, 3/10D, 3/10E) to fast ignition geometry with gold cone (3/10F) linked to the shell (3B) arrived by the ignitor beams (2A) in reactor vessel (6) and energetic beans beams (8) in the exhaust vessel (13,14,15).

47) PROCESSES AND BEAMS FROM THERMONUCLEAR FUSION MICRO REACTIONS,” according to claim (10), characterized by the beam (8) constituted from x-ray laser pumped by micro/mini fission/fusion explosions.

48) PROCESSES AND BEAMS FROM THERMONUCLEAR FUSION MICRO REACTIONS,” according to claim (10), characterized by the beam (8) constituted from y-ray laser pumped by micro/mini fission/fusion explosions.

49) PROCESSES AND BEAMS FROM THERMONUCLEAR FUSION MICRO REACTIONS,” according to claim (10), characterized by the target (10) with cylindrical/spherical geometry constituted of μg of plastic foam (10D), μg/mg of gold (10C), μg/mg of DT (10A) and the mean fuel (10B) with μg/mg of DHe3/T_{X}DHe3.

50) PROCESSES AND BEAMS FROM THERMONUCLEAR FUSION MICRO REACTIONS,” according to claim (10), characterized by the protector shield (14) constituted from steel and carbon-carbon composite.

51) PROCESSES AND BEAMS FROM THERMONUCLEAR FUSION MICRO REACTIONS,” according to claim (10), characterized by the protector shield (14) constituted from Kevlar and graphite.

52) PROCESSES AND BEAMS FROM THERMONUCLEAR FUSION MICRO REACTIONS,” according to claim (10), characterized by the injector system (19) in the reactor vessel (6) by electromagnetic means.

53) PROCESSES AND BEAMS FROM THERMONUCLEAR FUSION MICRO REACTIONS,” according to claim (10), characterized by the injector system (19) in the reactor vessel (6) by electrodynamics means.

54) PROCESSES AND BEAMS FROM THERMONUCLEAR FUSION MICRO REACTIONS,” according to claim (10), characterized by the injector system (19) in the exhaust (13,14,15) constituted by gas trigger (19A), a control valve (19B), an criostate (19C), a system of gas remove (19D), suction pumps (19E) and light detectors (19F1 e 19F2) and cameras (19G).

55) PROCESSES AND BEAMS FROM THERMONUCLEAR FUSION MICRO REACTIONS,” according to claim (10), characterized by the production system (20) from fuel (3,10) by cryogenic and polymerization.
